(19) United States
(12) Patent Application Publication
(10) Pub. No.: US 2013/0150137 A1
(43) Pub. Date: Jun. 13, 2013

(54) RoX METHOD OF PLAYING ROCK, PAPER, SCISSORS AS A BOARD GAME

(71) Applicants: Robert Brian Sommers, Pittsburgh, PA (US); Aidan Yoshiro Sommers, Pittsburgh, PA (US); Patricia Mariko Sommers, Pittsburgh, PA (US)

(72) Inventors: Robert Brian Sommers, Pittsburgh, PA (US); Aidan Yoshiro Sommers, Pittsburgh, PA (US); Patricia Mariko Sommers, Pittsburgh, PA (US)

(21) Appl. No.: 13/711,756

(22) Filed: Dec. 12, 2012

Related U.S. Application Data
(60) Provisional application No. 61/569,372, filed on Dec. 12, 2011.

(51) Int. Cl. A63F 3/00; A63F 13/00

(52) U.S. Cl. CPC A63F 3/00003; A63F 13/005
USPC 463/9; 273/271

(57) ABSTRACT

A board game for at least two opposing players that is designed to incorporate the competitive game concept of rock-paper-scissors. The board game includes a game board with a plurality of rows and columns that form a checkered grid pattern with a plurality of grid cells formed by the rows and columns. The opposing players use game pieces designated with at least one identifying characteristic for each opposing player, and place them, in alternating moves, in the grid cells. The goal of the game is to use the game pieces, in a single game, to form the pattern of game elements representing rock, paper and scissors, and with the rock game element beating the scissors or no game element, the paper game element beating the rock or no game element, and the scissors game element beating the paper or no game element. Other game elements can also be used. The board game can include a wild card. In addition, the board game can be played in such a manner that players accumulate points for various types of game play.

### CROSS REFERENCE TO RELATED APPLICATIONS

The present invention claims benefit of U.S. Provisional Application Ser. No. 61/569,372, entitled “RoX METHOD OF PLAYING ROCK, PAPER, SCISSORS AS A BOARD GAME” filed on Dec. 12, 2011, which is incorporated herein by reference.

### FIELD OF THE INVENTION

This invention relates generally to a virtual or physical board game for playing a variation of rock, paper and scissors.

### BACKGROUND OF THE INVENTION

The present invention is a unique virtual or physical board game for playing a variation of rock-paper-scissors. The traditional Rock-paper-scissors game is a hand game played by two people. The game is also known as roshambo, or by other orderings of the three items (with “stone” sometimes substituting for “rock”). The players usually count aloud to four, or speak the name of the game (e.g. “Rock Paper Scissors!” or “Ro Sham Bo!”), each time either raising one hand in a fist and swinging it down on the count or holding it behind. On the third count (saying, “Shoot!” or “Go!” “Scissors!” or “Bo!”), the players change their hands into one of three gestures, which they then “throw” by extending it towards their opponent. Variations include a version where players use only three counts before throwing their gesture (thus throwing on the count of “Scissors!” or “Bo!”, or a version where they shake their hands three times before “throwing.” The gestures are (in the 3 gesture version):
Rock, represented by a clenched fist.
Scissors, represented by two fingers extended and separated, sometimes coming together
Paper, represented by an open hand, with the fingers extended and touching, in order to represent a sheet of paper (horizontal).

The objective is to select a gesture which defeats that of the opponent. Gestures are resolved as follows:
Rock blunts or breaks scissors: rock defeats scissors.
Scissors cut paper: scissors defeats paper.
Paper covers, sands or captures rock: paper defeats rock.

If both players choose the same gesture, the game is tied and the players throw again.

The present invention relates to an improved method of playing rock-paper-scissors on a physical, virtual or electronic game board comprised of a grid-pattern.

### SUMMARY OF THE INVENTION

This present disclosure provides a strategy game of rock-paper-scissors played on a physical, virtual or electronic game board comprised of a checkered grid or grid pattern that forms grid cells. In a preferred embodiment, the game as called “RoX.” The grid pattern of the game board can have varying geometries, internal orientations and overall sizes, and can also have varying numbers and shapes of grid cells, and a varying numbers of columns and row.

Players alternate placing designated tokens or game pieces into the gird cells or spaces on the game board, with a goal of forming pre-defined patterns or elements on the board that correspond to the attributes of “rock,” “paper,” and “scissors.” Each player's tokens or game pieces will have identifying characteristics unique to that player—such as, for example, the same shape, markings and/or colors—so as to distinguish the tokens or game pieces associated with each players on the game board. Each pattern or game element, in turn, can have an associated value (i.e., “points”) that determines the winner of each game or battle. In general, player victory is derived from the hierarchy of Rock-Paper-Scissors, i.e., where a Rock pattern defeats a Scissors pattern, a Paper pattern defeats a Rock pattern, and a Scissors pattern defeats a Paper pattern. Where values or points are associated with a particular pattern, points can be accumulated during individual games to a target “winning” number of points. Games, in turn, can be incorporated into sets and matches for extended play between players (or teams of players).

The alternating play of player tokens or game pieces is similar to tic-tac-toe in that a game piece is placed by a player with the strategy objectives of (1) forming part of desired pattern or game element, and/or (2) blocking the efforts of an opposing player to form a desired pattern or game element. As such, the game is not a game of a simple choice. Instead, the game requires a player to use strategy, both offensive and defensive, to achieve victory against the player's opponent(s) during game play or “battle.” Through alternating turns, the players each use their game pieces or tokens in connection with the playing grid, while utilizing their own strategy, in an attempt to win more points than their opponent(s).

### BRIEF DESCRIPTION OF THE DRAWINGS

FIG. 1 is a perspective view of one embodiment of the game board of the present invention without game pieces.

FIG. 2 is a perspective view of another embodiment of the game board of the present invention without game pieces.

FIG. 3 is a perspective view of one embodiment of the game board of the present invention with game pieces showing a Rock game element patterns.

FIG. 4 is a perspective view of one embodiment of the game board of the present invention with game pieces showing Paper game element patterns.

FIG. 5 is a perspective view of one embodiment of the game board of the present invention with game pieces showing Scissors game element patterns.

FIG. 6 is a perspective view of one embodiment of the game board of the present invention with game pieces showing game play where Player 1 (white game pieces) has formed Rock to beat Player 2 (black game pieces), who has formed Scissors.

### DETAILED DESCRIPTION OF THE INVENTION

The present invention relates to a game involving the concept of rock-paper-scissors, with game pieces being played on a physical, virtual or electronic game board comprised of a grid-pattern that forms grid cells. In particular, the present invention provides a game of strategy where opposing players place game pieces in the grid cells of a game board, in alternating play, to create, in one preferred embodiment, rock, paper and scissors patterns and also to block the efforts of opposing players in forming the same patterns.

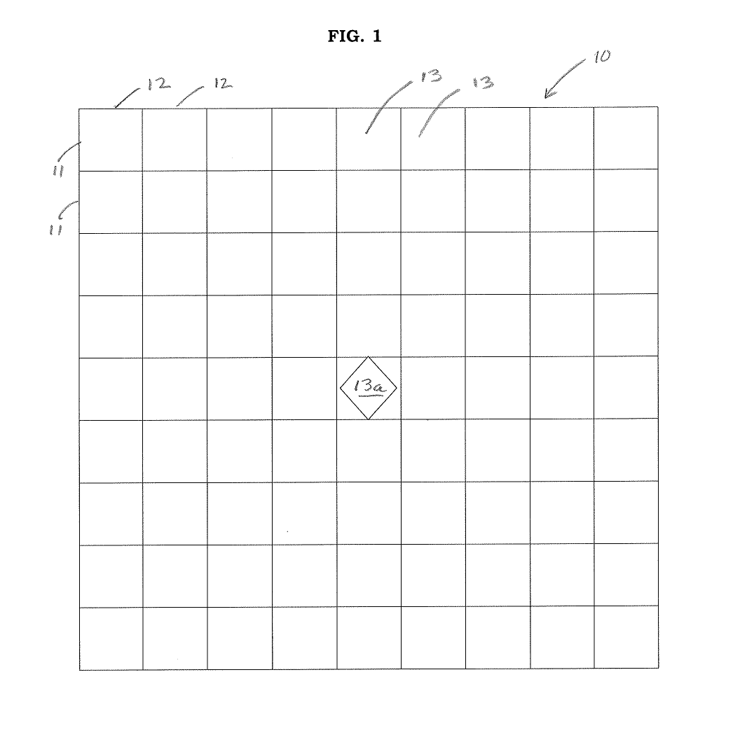

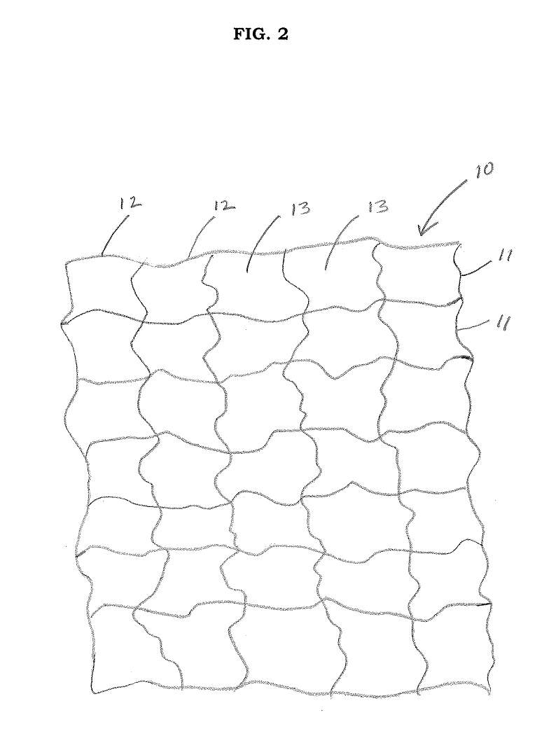

The Game Board. Referring to FIG. 1, the game board 10 of the present invention is a two-dimensional board comprised of a plurality of rows 11 and columns 12 that form grid cells 13. In FIG. 1, game board 10 has nine row and columns. The number of rows and columns can vary in the game, and they can be unequal in number (that is, the number of rows does not have to equal the number of columns). As such, the overall shape of the game board can vary. The orientation of the grid can vary, such that, for example, it may be diagonal. Other orientations can also be used. In addition, the game board may have ornamental attributes such as varying borders, colors, backgrounds, themes, etc. The shapes of the grid cells 13 can also vary, Thus, while grid cells 13 are shown as squares in FIG. 1, they can other regular or irregular shapes, such as shown in FIG. 2, where grid cells 13 have irregular shapes. In one preferred embodiment, so as to allow for sufficient game space, the game board includes at least six rows and six columns. In one embodiment of the invention, game board 10 can have one or more “wild card” grid cell 13a, which is discussed more fully below.

Game board 10 can be a physical, virtual or electronic game board. As a virtual or electronic game board, the game can be played on a computer, laptop, smart pad or smart phone, along with other similar electronic devices.

Players.

In a preferred embodiment, two players are involved in playing the game, but more than two players may be involved. For example, two opposing teams, with each team having multiple players, can play the game. In addition, two or more opposing players may play the game.

The Game Pieces and Game Patterns.

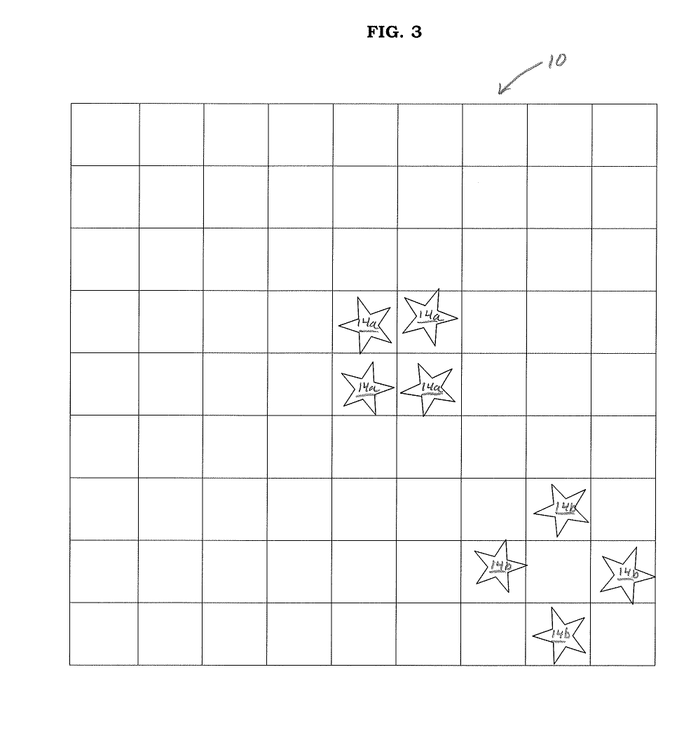

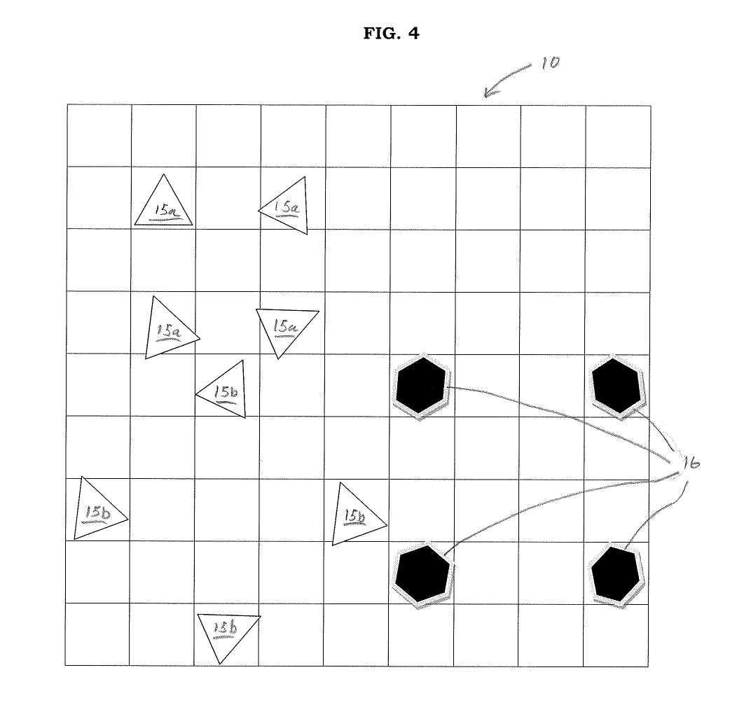

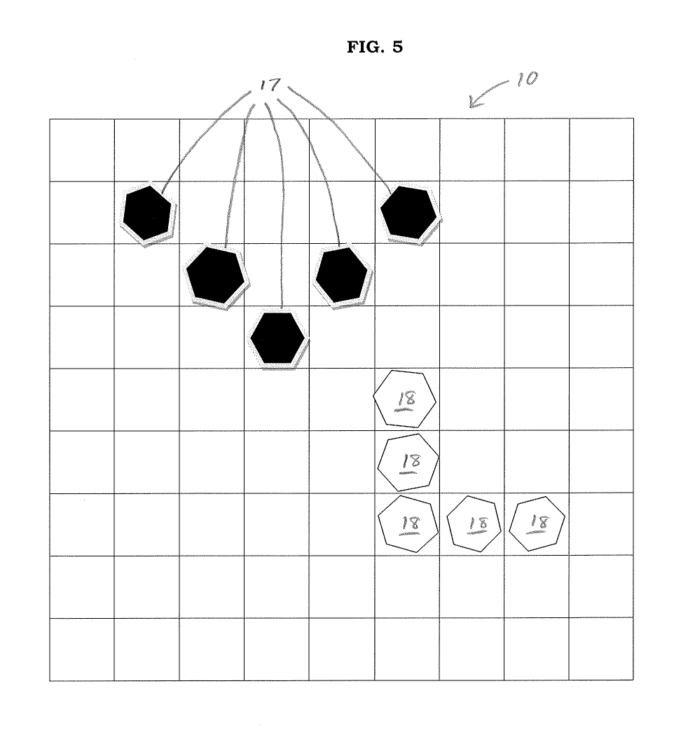

Each opposing player (or team comprised of multiple players) has a unique type or form of game piece or token that is used during game play. More directly, each opposing player uses game pieces or tokens with identifying characteristics unique to that player—such as, for example, the same shape, markings and/or colors—so as to distinguish the tokens or game pieces associated with each players on the game board. FIGS. 3, 4 and 5 shows varying types of game pieces that may be used. In FIG. 3, game pieces 14a and 14b are shown for one player, with game pieces 14a and 14b having the shape of white star. In FIG. 4, game pieces 15a, 15b, and 16 on game board 10. Games pieces 15a and 15b, for one player, are shown as white triangles, and game pieces 16, for one player, are shown as black hexagons or rocks. The shape of the game pieces can be regular or irregular. In FIG. 5, the game pieces 17 are shown for one player as black hexagons or rocks, and games pieces 18 are shown for a second player as white hexagons or rocks.

Game pieces, such as games pieces can be a physical, virtual or electronic game board. As such, games pieces can be used on a physical game board, or a virtual or electronic game board. Game pieces used with a physical game board can by three-dimensional.

During game play, the game pieces are used to form competitive game elements or patterns (and also to block the formation of patterns by opposing players. In the standard Rock-Paper-Scissors format, the patterns that a player seeks to form with game pieces are comprised of (1) a rock, (2) paper, and (3) scissors. In other embodiments of the game, other game elements or patterns may be used to correspond with hand symbol variations on Rock-Paper-Scissors, such as Rock-Paper-Scissors-Spock.

FIGS. 3, 4 and 5 show the game patterns used in connection with the standard Rock-Paper-Scissors format. FIG. 3 shows a “rock” symbol as preferably being formed by four game pieces 14a which are placed in adjoining grid cells, with each pair of game pieces lying the same column or row forming the sides of a square. In an alternative embodiment, a “rock” may also be formed by games pieces 14b which adjoin to form a square along the diagonals created between grid cells. In game play, players, as they choose before a game, can use either or both of these patterns to create a “rock.”

FIG. 4 shows variations on how a “paper” symbol can be formed. In a preferred embodiment, four game pieces 15a are placed in grid cells, with each pair of game pieces lying the same column or row to form the sides of a square, i.e., the four games pieces represent the four corners of a piece of paper, with at least one grid cell or space between games pieces that lie within a particular row or column (to distinguish the paper symbol from the rock symbol). Game pieces 16 show, in another embodiment, a paper pattern that is formed where two grid cells or spaces lie between each game piece 16. In a preferred embodiment, the spaces between all game pieces that form the corners of the pattern of a piece of paper are equal; however, the spacing between the game pieces on the tops and bottoms of a paper pattern can vary from the spaces along the sides. In another embodiment, as shown FIG. 4, a paper pattern can be formed by game pieces 15b, where such pieces are placed in diagonal rows, with spaces in between, to form the corners of the paper pattern. In game play, players, as they choose before a game, can use one or more of these patterns to create a “paper.”

FIG. 5 shows variations on how a “scissors” symbol can be formed. In a preferred embodiment, five adjoining game pieces 17 are placed to form an angle in one row and one column of game board 10. In an alternative embodiment, five games pieces 18 can be used to create a “scissors” pattern by forming an angle through grid cells that align diagonally. In game play, players, as they may choose before a game, can use either or both of these patterns to create a “scissors.”

Additional patterns can also be used if the game involves other competitive game elements such as, for example, “lizard” or “Spock.”

If wild card grid cell or wild square 13a (as shown in FIG. 1) is used, this wild square can be used or shared by any player to help form or create a particular element or pattern. In a preferred embodiment, this wild square is known as a RoXRock square. The wild square remains in one position during game play.

Playing the Game.

A game begins by selection of the number of players and/or teams. Again, in a preferred embodiment, two opposing players or teams are involved in game play. Opposing players select the game pieces that each player will use during game play. If the game is played on an electronic device, the device can be used, at the beginning of the match, to randomly select a player to start the first drop. In the case where the game is not played on an electronic device, or should the players otherwise choose, the players can decide among themselves as to who will play first.

Before game play begins, players, if given the option, can also select the types of patterns that can be used to create “rock,” “paper,” “scissors” or any other elements/patterns. Also, if an option exists, players can determine whether or not to use a wild square position on the game board and where to place the wild square.

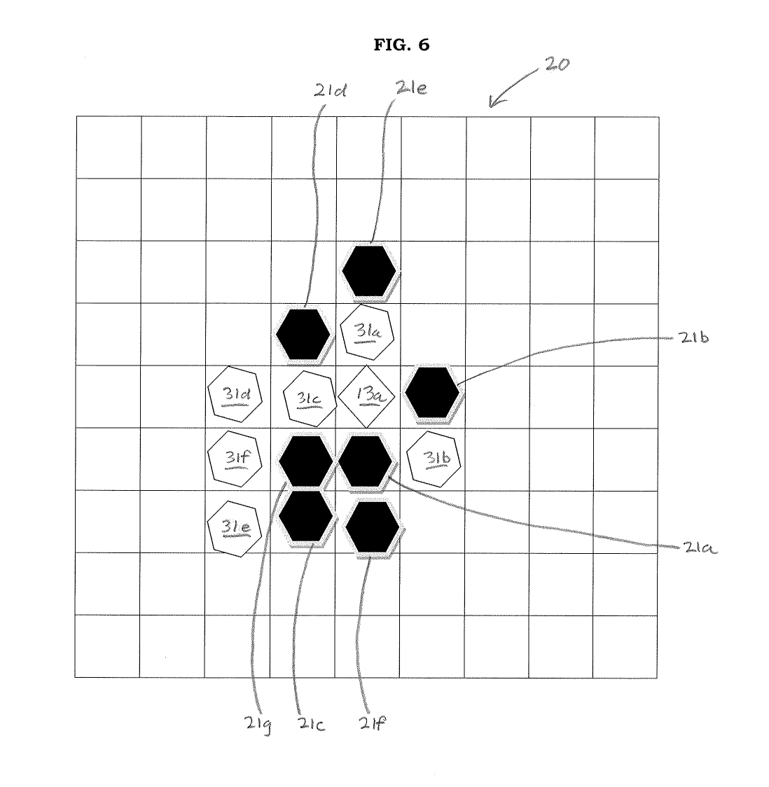

Referring to FIG. 6, game begins by one player placing his or her game piece on board 20. As shown in FIG. 6, which shows a game between two players—Player A and Player B—Player played his black game piece 21a first, followed by Player B, with a placement of white game piece 31a. The players then continue to alternate playing their respective game pieces until a first player completes an element or pattern. In some instances, more than one element or pattern can be completed with the play of a game piece. When the game is run on an electronic device, when a player is first to complete a pattern or element the screen or game board will display a picture of the element created. If more than one pattern or element is created, then both will be shown. At this point of the game or battle, the opposing player has one final drop to complete an element or elements. The opposing player must play a final game piece on the game board, even if that player cannot create an element. In a preferred embodiment of the game, the other player than has one last chance to place a game piece before the opposing player-formed games elements or patterns are compared. As shown in FIG. 6, Player A and Player B placed the following games pieces in alternating sequence: 21a, 31a, 21b, 31b, 21c, 31c, 21d, 31d, 21e, 31e, 21f, 31f, and 21g.

During the game play shown in FIG. 6, Player B's game piece 31b was placed, for example, to block Player A from forming a rock pattern using wild square 13a. Ultimately, Player B used game pieces 31c, 31d, 31e, and 31f, along with wild square 13a, to form a scissors pattern. However, after Player B finished this pattern with game piece 31f, Player A was give one last play and used game piece 21g to complete a rock pattern. Thus, in this game, although Player B finished a game element first—a scissors—Player A finished a game element—a rock—which wins over scissors. If Player A had been unable to complete any game element or pattern, or had only completed a paper game element, Player B would win. Simple play like this, i.e., comparison of completed game elements/patterns, can be done as part of rounds or sets, i.e., best out of three or five games or battles, or in other competitive formats. The elements made by each player (if both are completed) are compared and the winner is declared based upon the traditional rock, paper, scissors game, i.e., paper covers rock, rock crushes scissors, scissors cut paper. If the players wish to play another game, the losing player plays first in the next game. If a game or battle ends in a tie, the players can again alternate starting for the next game.

Point Scoring.

In an alternate form of the game, for example, points are earned by creating one of the three game/battle patterns or elements—rock, paper, or scissors—as well as for winning particular battles. Points are then accumulated to determine who wins a round. The more points a player earns, the closer that player is to winning a round. The more rounds that a player wins, in turn, can be used to determine the winner of a match, i.e., the best of three rounds (the first player to win two rounds, or the best of five rounds (the first player to win three rounds.

In this alternate embodiment of the game, opposing players, at the beginning of match enter their names manually or in the associated electronic device to allow for tracking of accumulated points in each round and also to total and track the rounds won in a match. For example, a round could be won when one player obtains five points before the opposing player does. The players can also select the number of rounds in a match.

If battle ends in a tie, then the player who did not earn any points for the tie starts the next battle with the first drop.

In this alternate embodiment of the game, a preferred form of scoring can involve the following rules (although other scoring rules and designated points for game element formation and game play can also be used):

1. Rock (“R”) beats Scissors (“S”)=1 point

2. Paper (“P”) covers Rock (“R”)=1 point

3. Scissors (“S”) cuts Paper (“P”)=2 points (Scissors require 5 game pieces while the other elements require only 4)

4. If a player creates one or more elements and the opposing player creates none with that player's final play, add 1 extra point to the winner of the battle.

5. If a winning player creates more than one element, add 1 extra point to the winner of the battle

6. In the event of a tie, ½ point is added to the player who is trailing in points for that round. If both players are tied during a round, then the ½ point is added to the player who did not start the battle.

7. Based on these rules, the following scores can be generated from the game play results shown below:
R v S=R wins 1 point
R v 0=R wins 2 points
R v R=TIE
P v R=P wins 1 point
P v 0=P wins 2 points
P v P=TIE
S v P=S wins 2 points
S v 0=S wins 3 points
S v S=TIE
RR vs. P=RR wins 3 points
RR vs. S=RR wins 4 points
RR vs. R=RR wins 3 points
RP vs. P=RP wins 3 points
RP vs. S=RP wins 4 points
RP vs. R=RP wins 3 points
RS vs. S=RS wins 4 points
RS vs. P=RS wins 4 points
RS vs. R=RS wins 3 points
PP vs. P=PP wins 3 points
PP vs. R=PP wins 4 points
PP vs. S=PP wins 3 points
PS vs. P=PS wins 5 points
PS vs. R=PS wins 4 points
PS vs. S=PS wins 4 points
SS vs. P=SS wins 6 points
SS vs. R=SS wins 4 points
SS vs. S=SS wins 4 points
RR vs. RP=RP wins 3 points
RR vs. RR=TIE
RR vs. RS=RR wins 3 points
RR vs. PP=PP wins 3 points
RR vs. SS=RR wins 3 points
RR vs. PS=TIE
PP vs. PP=TIE
PP vs. SS=SS wins 5 points
PP vs. RS=TIE
PP vs. SP=SP wins 3 points
PP vs. RP=PP wins 3 points
SS vs. SS=TIE
SS vs. RP=SS wins 3 points
SS vs. RS=RS wins 3 points
SS vs. PS=SS wins 3 points
RS vs. PS=RS wins 3 points
RS vs. RP=RP wins 3 points
RS vs. RS=TIE
RP vs. RP=TIE
RP vs. SP=SP wins 3 points
SP vs. SP=TIE
RPS vs. anything=RPS WINS ENTIRE MATCH
RPS vs. RPS=TIE

By way of explanation, in the first example above where the winning player forms two elements, i.e. RR v P, RR loses to P on R v P, but the second R generates 1 points for a win, a second point because it is matched against no (0) elements for P, and a third point because RR created two elements. The same rules apply for the other scoring examples listed.

The point system described above represents one embodiment of the invention, and other point systems can be used. For example, the player a particular game or battle can also accumulate points, or the number of points assigned for the creation of a particular element or for particular game play can be changed, and the total points required to win a game or battle can vary.

The invention is described above in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated apparatus, and such further applications of the principles of the invention illustrated herein, as would normally occur to persons skilled in the art to which the invention relates.

What is claimed is:

1. A board game for at least two opposing players, the game designed to incorporate the competitive game concept of rock-paper-scissors, and the game comprising:
a game board having a plurality of rows and columns that form a checkered grid pattern with a plurality of grid cells formed by the rows and columns;
a plurality of game pieces designated with at least one identifying characteristic for each opposing player, the game pieces being played, in alternating moves, in the grid cells by opposing players with a goal of using the game pieces, in a single game, to form the pattern of game elements representing rock, paper and scissors, and with the rock game element beating the scissors or no game element, the paper game element beating the rock or no game element, and the scissors game element beating the paper or no game element.

2. A board game, as in claim 1, wherein the checkered grid pattern is a physical game board.

3. A board game, as in claim 1, wherein the checkered grid pattern is virtual.

4. A board game, as in claim 1, wherein the checkered grid pattern is electronic.

5. A board game, as in claim 1, further comprising at least wild square, the at least one wild square being chosen prior to game play and providing a grid cell that all opposing players can use as a game piece, along with the opposing player's other game pieces, to form a game element on the game board.

6. A board game, as in claim 1, wherein there are two opposing players.

7. A board game, as in claim 1 or 5, wherein a rock game element is formed by four game pieces in a pattern selected from the group consisting of:
a. Placing the game pieces in adjoining row and column grid cells to form a square;
b. Placing the game pieces in adjoining diagonal grid cells to form a square; and
c. Placing the game pieces in adjoining grid cells grid cells, either in rows and columns or diagonally, to form a square.

8. A board game, as in claim 1 or 5, wherein a paper game element is formed by four game pieces in a pattern selected from the group consisting of:
a. Placing the game pieces to form a square in rows and columns of the grid cells of game board, with at least one space between the game pieces in the same row or column;
b. Placing the game pieces to form a square in diagonal grid cells, with at least one space between adjoining games pieces in the same diagonal; and
c. Placing the game pieces in grid cells, either in rows and columns or diagonally, to form a square, with at least one space between adjoining games pieces.

9. A board game, as in claim 1 or 5, wherein a scissors game element is formed by five game pieces in a pattern selected from the group consisting of:
a. Placing the game pieces in adjoining grid cells to form an angle along a row and a column of the game board;
b. Placing the game pieces in adjoining grid cells to form an angle along diagonals of the game board; and
c. Placing the game pieces in adjoining grid cells to form an angle along either a row and a column or diagonals of the game board.

10. A board game, as in claim 1, wherein the game pieces can be used to form additional game elements.

11. A board game, as in claim 1, wherein the formation of game elements by game pieces and related game play are associated with points used to determine the winner of a game, the points being associated with all or some of the game element formation and game play selected from the group consisting of:
a. points associated with each forming a particular game element;
b. points associated with forming more than one game element;
c. points associated with winning a game;
d. points associated with a tie; and
e. points associated with the failure of an opposing player to create any game element.

12. A board game, as in claim 11, wherein accumulated points, at a preset amount over one or more individual games, determine the winner of a round of game play.

13. A board game, as in claim 12, wherein a winner is determined by winning majority of rounds in a preset amount of rounds in a match.

14. A method of playing a board game among a plurality of opposing players, the board game incorporating the game concept of rock, paper, scissors with a plurality of players, and comprising:
a. the placement, in alternating moves by opposing players, of a plurality of game pieces designated with at least one identifying characteristic for each opposing player, on a game board having a plurality of rows and columns that form a checkered grid pattern with a plurality of grid cells formed by the rows and columns, and with the games pieces being placed in the grid cells; and
b. the formation, in a single game, by placement of a player's game pieces on the game board, of game elements in patterns representing rock, paper and scissors, and with the rock game element beating the scissors or no game element, the paper game element beating the rock or no game element, and the scissors game element beating the paper or no game element.

15. The method of playing a board game, as in claim 14, wherein the game board is selected from the group consisting of a physical, virtual and electronic game board.

16. The method of playing a board game, as in claim 14, wherein the game board grid cells include at least wild square, the at least one wild square being chosen prior to game play and providing a grid cell that all opposing players can use as a game piece, along with the opposing player's other game pieces, to form at least one game element on the game board.

17. The method of playing a board game, as in claim 14 or 16, wherein:
a. A rock game element is formed by four game pieces in a pattern selected from the group consisting of:
1. Placing the game pieces in adjoining row and column grid cells to form a square;
2. Placing the game pieces in adjoining diagonal grid cells to form a square; and
3. Placing the game pieces in adjoining grid cells grid cells, either in rows and columns or diagonally, to form a square;
b. A paper game element is formed by four game pieces in a pattern selected from the group consisting of:
1. Placing the game pieces to form a square in rows and columns of the grid cells of game board, with at least one space between the game pieces in the same row or column;
2. Placing the game pieces to form a square in diagonal grid cells, with at least one space between adjoining games pieces in the same diagonal; and
3. Placing the game pieces in grid cells, either in rows and columns or diagonally, to form a square, with at least one space between adjoining games pieces; and
c. A scissors game element is formed by five game pieces in a pattern selected from the group consisting of:
1. Placing the game pieces in adjoining grid cells to form an angle along a row and a column of the game board;
2. Placing the game pieces in adjoining grid cells to form an angle along diagonals of the game board; and
3. Placing the game pieces in adjoining grid cells to form an angle along either a row and a column or diagonals of the game board.

18. The method of playing a board game, as in claim 14, wherein the game pieces can be used to form additional game elements.

19. The method of playing a board game, as in claim 14, wherein the formation of game elements by game pieces and related game play are associated with points used to determine the winner of a game, the points being associated with all or some of the game element formation and game play selected from the group consisting of:
a. points associated with each forming a particular game element;
b. points associated with forming more than one game element;
c. points associated with winning a game;
d. points associated with a tie; and
e. points associated with the failure of an opposing player to create any game element.

20. The method of playing a board game, as in claim 14, wherein accumulated points, at a preset amount over one or more individual games, determine the winner of a round of game play, and a winner is determined by winning majority of rounds in a preset amount of rounds in a match.
